(19) United States
(12) Patent Application Publication
(10) Pub. No.: US 2006/0037971 A1
(43) Pub. Date: Feb. 23, 2006

(54) Positive displacement pump

(76) Inventors: James J. Minard, South Beloit, IL (US); Pete McNamee, Beloit, WI (US); Mark Bush, Rockton, IL (US)

Correspondence Address: CARLSON, GASKEY & OLDS, P.C., 400 WEST MAPLE ROAD, SUITE 350, BIRMINGHAM, MI, 48009, US

(21) Appl. No.: 10/955,175

(22) Filed: Sep. 30, 2004

Related U.S. Application Data
(60) Provisional application No. 60/602,793, filed on Aug. 19, 2004.

(51) Int. Cl. B67D 5/60

(52) U.S. Cl. 222/145.5

(57) ABSTRACT

A pump in a beverage system pumps a set amount of concentrate from a concentrate container and into a mixing container for mixing with water to form a beverage. The pump includes a motor that drives a piston both linearly and rotatably. A portion of the piston is received in a compartment of the pump and includes a substantially cylindrical body surface having a cylindrical portion and an irregular surface. When concentrate is to be drawn into the compartment, the irregular surface of the piston is proximate to the inlet of the pump and the cylindrical surface covers the outlet. As the piston moves, the concentrate is drawn into a part of the compartment defined between the walls of the compartment and the irregular surface of the piston. The irregular surface of the piston eventually approaches the outlet, and the concentrate trapped between the irregular surface and the walls of the compartment is expelled through the outlet.

This application claims priority to U.S. Provisional Patent Application No. 60/602,793 filed on Aug. 19, 2004.

### BACKGROUND OF THE INVENTION

The present invention relates generally to a positive displacement pump employed in a beverage system that is not affected by changes in temperature and viscosity of a fluid pumped by the pump.

Beverages systems are employed to make beverages and soft drinks. A flavored concentrate is mixed with water to form the beverage. Typically, the flavored concentrate is stored in a concentrate container. When the beverage is to be made, a pump draws a set amount of the flavored concentrate into a container for serving. Water is added to the flavored concentrate to form the beverage.

A drawback to prior art beverage systems is that the pump is affected by changes in temperature and viscosity of the concentrate. As the temperature of the concentrate decreases, the viscosity increases, decreasing the flow rate of the concentrate though the pump. That is, pump output is dependant upon product viscosity. Therefore, as the temperature of the concentrate decreases, the pumping rate of the pump must increase to compensate for the decrease in the flow of the concentrate. This is disadvantageous because a decrease in the rate of flow of the pump can dilute the beverage, affecting product quality.

Hence, there is a need in the art for a positive displacement pump that is not affected by temperature and viscosity changes in the fluid that is pumped and that overcomes the drawbacks and shortcomings of the prior art.

### SUMMARY OF THE INVENTION

A beverage system includes a concentrate container that contains a flavored concentrate and a fluid container that contains water. A pump pumps a set amount of the concentrate from the concentrate container and into a mixing container. Water from the fluid container is also added to the mixing container. The concentrate and water are mixed to form a beverage.

The pump controls the flow of concentrate into the mixing container. The pump includes a motor that is used to drive a motor shaft including a piston interface knuckle. The piston interface knuckle engages a piston. As the motor shaft rotates, engagement of the piston interface knuckle with the piston causes the piston to both move linearly and to rotate.

A portion of the piston is received in a compartment of the pump. The compartment has a fixed volume and is not expandable. Movement of the piston by the motor draws a set amount concentrate into the compartment through an inlet and expels the concentrate from the compartment through an outlet. The portion of the piston received in the compartment includes a cylindrical body portion having a cylindrical surface and an irregular surface. The irregular surface can be flat or u-shaped.

When concentrate is to be drawn into the compartment, the piston is rotated by the motor such that the irregular surface is proximate to the inlet of the pump. As the piston moves linearly and rotates, the concentrate is drawn into a part of the compartment defined between the walls of the compartment and the irregular surface of the piston. The cylindrical body portion engages the outlet, preventing concentrate from being expelled through the outlet.

As the piston continues to rotate, the concentrate trapped between the irregular surface of the piston and the walls of the compartment moves from the inlet and towards the outlet. The cylindrical body portion of the piston eventually engages the inlet, preventing more concentrate from being drawn into the pump. The irregular surface of the piston eventually approaches the outlet, and the concentrate trapped between the irregular surface and the walls of the compartment is expelled through the outlet. The concentrate can then be mixed with water in the mixing container to form a beverage.

These and other features of the present invention will be best understood from the following specification and drawings.

### BRIEF DESCRIPTION OF THE DRAWINGS

The various features and advantages of the invention will become apparent to those skilled in the art from the following detailed description of the currently preferred embodiment. The drawings that accompany the detailed description can be briefly described as follows:

FIG. 1 schematically illustrates a front view of a beverage system used to make a beverage;

FIG. 2 illustrates a cross-sectional perspective view of a pump of the present invention;

FIG. 3 illustrates a perspective view of a first embodiment of a piston of the pump of the present invention;

FIG. 4 illustrates a perspective view of a second embodiment of the piston of the pump of the present invention; and

FIG. 5 illustrates a cross-sectional view of movement of the piston during operation of the pump.

### DETAILED DESCRIPTION OF THE PREFERRED EMBODIMENT

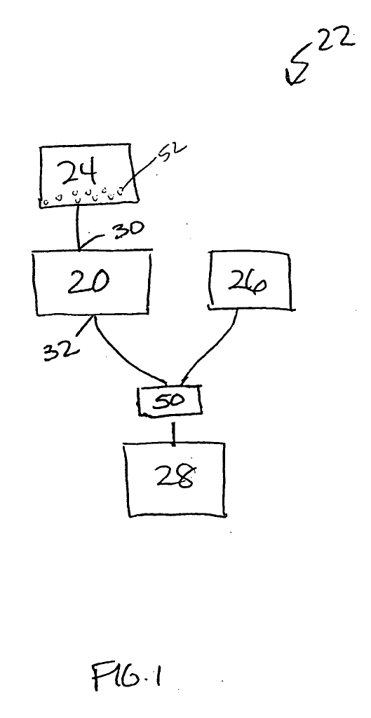

FIG. 1 schematically illustrates a beverage system 22 of the present invention. The beverage system 22 can be used to make beverages, soft drinks, milkshakes, dairy products or other frozen desserts. The beverage system 22 includes a concentrate container 24 that contains a flavored concentrate 52. A pump 20 draws a set amount of the concentrate 52 from the concentrate container 24 and into an inlet 30 of the pump 20. The pump 20 controls the flow of concentrate 52, and the concentrate 52 exits the pump 20 through an outlet 32. The pumped concentrate 52 then flows into a mixing container 50. Water contained in a water container 26 is also added to the mixing container 50 and mixed with the concentrate 52 to form the beverage. The beverage is then added to a cup 28 for serving.

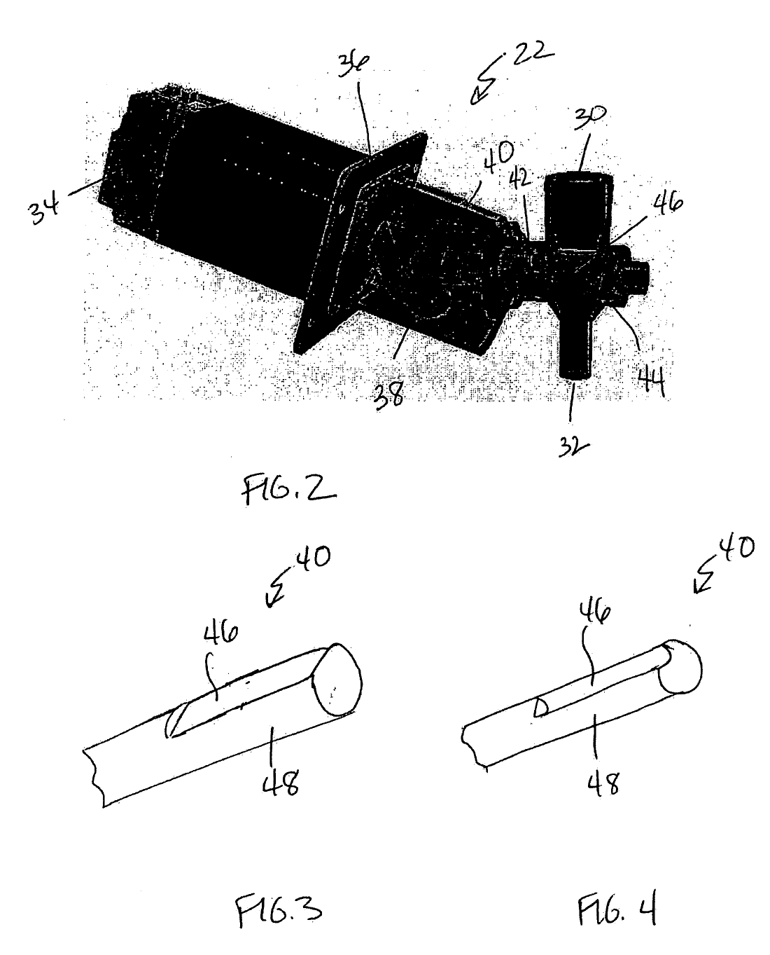

FIG. 2 schematically illustrates the pump 20 of the present invention. The pump 20 includes a motor 34 that is used to drive a motor shaft 36. The motor shaft 36 includes a piston interface knuckle 38. As the motor shaft 36 rotates, the attached piston interface knuckle 38 also rotates. The piston interface knuckle 38 engages a piston 40. As the motor shaft 36 rotates, engagement of the piston interface knuckle 38 with the piston 40 causes the piston 40 to both move linearly and to rotate. That is, the piston 40 is nutating.

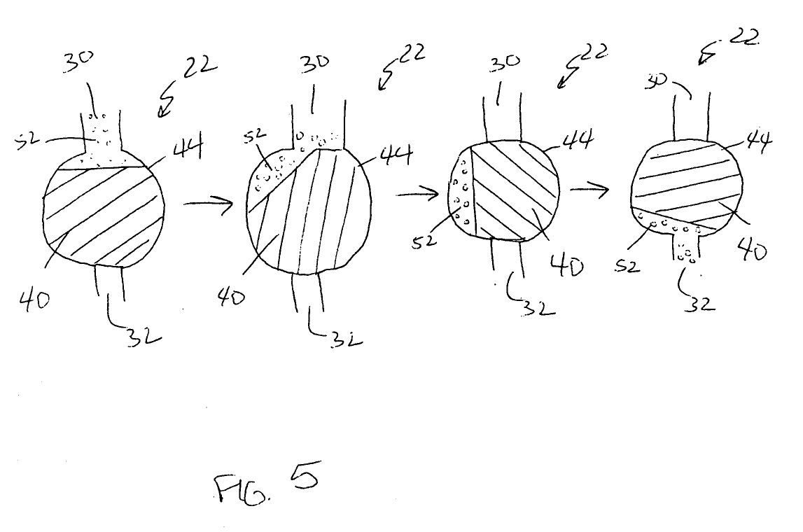

A portion 42 of the piston 40 is received in a compartment 44 of the pump 20. The compartment 44 has a fixed volume and does not expand or contract during operation of the pump 20. Preferably, the compartment 44 is made of steel. Movement of the piston 40 by the motor 34 draws concentrate into the compartment 44 through the inlet 30 and releases the concentrate from the compartment 44 through the outlet 32. The portion 42 of the piston 40 received in the compartment 44 is substantially cylindrical in shape and includes a cylindrical surface 48 having an irregular surface 46. As shown in FIG. 3, the irregular surface 46 can be a flattened surface. Alternately, as shown in FIG. 4, the irregular surface 46 can be a cupped or u-shaped surface. A space is defined between the irregular surface 46 of the piston 40 and the walls of the compartment 44.

As shown in FIG. 5, when the set amount of the concentrate 52 is to be drawn into the compartment 44, the piston 40 is rotated by the motor 34 such that the irregular surface 46 of the piston 40 is proximate to the inlet 30 of the pump 20. The irregular surface 46 is spaced from the inlet 30, and therefore the set amount of concentrate 52 can be drawn into the space defined between the walls of the compartment 44 and the irregular surface 46 of the piston 40. As the piston 40 continues to rotate, the irregular surface 46 moves away from the inlet 30 and towards the outlet 32, continuing to draw the concentrate 52 into the compartment 44. At this time, the cylindrical surface 48 engages the outlet 32, preventing the concentrate 52 from being expelled through the outlet 32.

As the piston 40 continues to rotate, the concentrate 52 trapped in the space between the irregular surface 46 of the piston 40 and the walls of the compartment 44 moves from the inlet 30 and towards the outlet 32. Eventually, the cylindrical surface 48 of the piston 40 engages the inlet 30, preventing more concentrate 52 from being drawn into the pump 20. The irregular surface 46 of the piston 40 eventually approaches the outlet 32, and the concentrate trapped in the space between the irregular surface 46 and the walls of the compartment 44 is expelled through the outlet 32. The concentrate 52 can then be mixed with water in the mixing container 50 to form the beverage.

When more concentrate 52 is to be drawn into the pump 20, the piston 40 is rotated such that the irregular surface 46 again approaches the inlet 30, drawing more concentrate 52 into the compartment 44. The cycle is then repeated to expel the concentrate 52 from the outlet 32 of the pump 20.

The pump 20 of the present invention does not include any expandable components, and therefore the speed of the pump 20 does not change if there are any changes in viscosity or temperature of the concentrate 52. That is, the compartment 44 is made of steel, and therefore the compartment 44 has a fixed volume and fixed shape. Therefore, the pump 20 of the present invention does not need a speed adjustment motor to compensate for changes in viscosity or temperature of the concentrate 52 and to regulate the speed of the pump 20 as the temperature and viscosity of the concentrate 52 changes to deliver a given amount of the concentrate 52. Additionally, the pump 20 minimizes the operator interface required for the beverage system 22, lowering the total cost of the beverage system 22 and improving product consistency.

Although a beverage system 22 is illustrated and described, it is to be understood that the pump 20 of the present invention can be used in other systems. For example, the pump 20 can be used in a soft drink system. In this example, the pump 22 pumps flavored syrup which is mixed with carbonated water to make a soft drink.

The foregoing description is only exemplary of the principles of the invention. Many modifications and variations are possible in light of the above teachings. It is, therefore, to be understood that within the scope of the appended claims, the invention may be practiced otherwise than using the example embodiments which have been specifically described. For that reason the following claims should be studied to determine the true scope and content of this invention.

What is claimed is:

1. A concentrate dispensing system comprising:
a concentrate container to store a concentrate;
a pump to control a flow of said concentrate from said concentrate container, said pump including a housing having a compartment, an inlet, and an outlet and the pump further including a piston having a cylindrical surface and an irregular surface, and a portion of said piston is received in said compartment, and said piston is moveable such that said irregular surface is near said inlet when said pump draws said concentrate into said compartment and said irregular surface is near said outlet when said pump expels said concentrate out of said compartment; and
a motor to move the piston.

2. The system as recited in claim 1 wherein said irregular surface is substantially flat.

3. The system as recited in claim 1 wherein said irregular surface is substantially u-shaped.

4. The system as recited in claim 1 wherein said housing is made of steel.

5. The system as recited in claim 1 wherein said housing is non-expandable.

6. The system as recited in claim 1 wherein said pump draws said concentrate from said concentrate container and into a mixing container.

7. The system as recited in claim 6 further including a fluid container that contains a fluid, and said fluid is mixed with said concentrate in said mixing container.

8. The system as recited in claim 7 wherein said fluid is water.

9. The system as recited in claim 1 wherein said motor includes a rotor shaft having a piston interface knuckle, and rotation of said motor shaft rotates said piston interface knuckle.

10. The system as recited in claim 9 wherein said piston interface knuckle engages the piston to move said piston.

11. The system as recited in claim 1 wherein said piston moves both linearly and rotationally.

12. The system as recited in claim 1 wherein during intake of said concentrate, said irregular surface is proximate to said inlet, and movement of said piston draws said concentrate through said inlet and into a space defined by said irregular surface and said compartment and said cylindrical surface engages said outlet to prevent said concentrate from flowing through said outlet.

13. The system as recited in claim 1 wherein during expulsion of said concentrate, said irregular surface is proximate to said outlet, and movement of said piston draws said concentrate out of a space defined by said irregular surface and said compartment and said cylindrical surface engages said inlet to prevent said concentrate from flowing into said inlet.

14. The system as recited in claim 1 wherein movement of said piston moves said concentration from said inlet to said outlet.

15. A concentrate dispensing system comprising:
a concentrate container to store a concentrate;
a fluid container to store a fluid;
a pump to control a flow of said concentrate from said concentrate container, said pump including a non-expandable housing having a compartment, an inlet and an outlet, the pump further including a piston having a cylindrical surface and an irregular surface, and a portion of said piston is received in said compartment, and said piston is moveable such that said irregular surface is near said inlet when said pump draws said concentrate into said compartment and said irregular surface is near said outlet when said pump expels said concentrate out of said compartment;
a motor to move the piston, said motor including a rotor shaft having a piston interface knuckle, and rotation of said motor shaft rotates said piston interface knuckle, wherein said piston interface knuckle engages said piston to move said piston; and
a mixing container, and said concentrate pumped by said pump and said fluid from said fluid container are mixed in said mixing container.

16. The system as recited in claim 15 wherein said irregular surface is substantially flat.

17. The system as recited in claim 15 wherein said irregular surface is substantially u-shaped.

18. The system as recited in claim 15 wherein said piston moves both linearly and rotationally.
